(19) United States
(12) Patent Application Publication
(10) Pub. No.: US 2024/0089881 A1
(43) Pub. Date: Mar. 14, 2024

(54) BASE STATION SYNCHRONIZATION USING UE MODEM

(71) Applicant: AIRSPAN IP HOLDCO LLC, Boca Raton, FL (US)

(72) Inventors: Yehezkel YACOBOVIZ, Givat Zeev (IL); Eyal VERBIN, Beer Yaacov (IL)

(73) Assignee: AIRSPAN IP HOLDCO LLC, Boca Raton, FL (US)

(21) Appl. No.: 18/274,530

(22) PCT Filed: Jul. 19, 2021
(86) PCT No.: PCT/IL2021/050876

§ 371 Date: Jul. 27, 2023

Related U.S. Application Data
(60) Provisional application No. 63/142,002, filed on Jan. 27, 2021.

(51) Int. Cl. H04W 56/00; H04W 48/16

(52) U.S. Cl. CPC H04W 56/0015; H04W 48/16

(57) ABSTRACT

A fifth generation (5G) standard cellular base station unit including at least one user equipment (UE) modem operative to receive wireless signals from at least one external base station and to derive at least one synchronization signal based on the wireless signals received from the at least one external base station, and a 5G base station sub-unit operative to receive the at least one synchronization signal from the at least one UE modem and to employ the at least one synchronization signal to synchronize internal functions of the 5G base station sub-unit.

### RELATED APPLICATIONS

Reference is hereby made to U.S. Provisional Patent Application No. 63/142,002, entitled BASE STATION SYNCHRONIZATION USING UE MODEM, and filed Jan. 27, 2021, the disclosure of which is hereby incorporated by reference and priority of which is hereby claimed, pursuant to 37 CFR 1.78(a)(4) and (5)(i).

### FIELD OF THE INVENTION

The present invention relates generally to base station synchronization and more particularly to Fifth Generation (5G) base station synchronization.

### BACKGROUND OF THE INVENTION

Various types of base station synchronization techniques are known in the art.

### SUMMARY OF THE INVENTION

The present invention seeks to provide methods and systems for improved base station synchronization, particularly useful although not limited to 5G base stations.

There is thus provided in accordance with a preferred embodiment of the present invention a fifth generation (5G) standard cellular base station unit including at least one user equipment (UE) modem operative to receive wireless signals from at least one external base station and to derive at least one synchronization signal based on the wireless signals received from the at least one external base station, and a 5G base station sub-unit operative to receive the at least one synchronization signal from the at least one UE modem and to employ the at least one synchronization signal to synchronize internal functions of the 5G base station sub-unit.

Preferably, the base station sub-unit is a gNB.

Alternatively, the base station sub-unit is a radio unit (RU).

In accordance with one preferred embodiment of the present invention, the UE modem does not include a Subscriber Identity Module (SIM).

Preferably, the UE modem is operative to communicate with the external base station until the UE modem receives from the external base station a timing advance value of the signals received from the external base station, and may or may not stop communicating with the external base station upon receiving the timing advance value.

Preferably, the unit also includes a bi-directional communication protocol between the base station sub-unit and the UE modem.

Preferably, the base station sub-unit is operative to provide information or queries to the UE modem and the UE modem is operative to function based on the information or queries.

Preferably, the base station sub-unit is operative to receive timing information from a network time protocol (NTP).

In accordance with another preferred embodiment of the present invention, the unit also includes a GNSS receiver included in the unit and in operative communication with the UE modem, the UE modem being operative to ascertain a geographical location of the base station unit and to provide the geographical location to the GNSS receiver, the GNSS receiver being operative to generate an additional synchronization signal based on the location and on a signal from at least one GNSS satellite, the base station sub-unit being operative to receive the additional synchronization signal from the GNSS receiver and to employ the additional synchronization signal to time synchronize the base-station sub-unit with the at least one GNSS satellite.

Preferably, the wireless signals include at least one of 5G standard signals, Long Term Evolution (LTE) standard signals, LTE-Machine Type Communication (LTE-M) standard signals and Narrowband Internet of Things (NB-IoT) standard signals.

Preferably, the UE modem is operative to select the external base station and to derive the at least one synchronization signal based on the wireless signals received from the external base station based on at least one of: a quality level of the wireless signals received from the external base station, a base station stratum level of the external base station as reported by the external base station, and a base station operator identity as reported by the external base station.

There is additionally provided, in accordance with another preferred embodiment of the present invention, a cellular base station unit including at least one user equipment (UE) modem not including a Subscriber Identity Module (SIM) and operative to receive wireless signals from at least one external base station and to derive at least one synchronization signal from the wireless signals received from the at least one external base station, and a base station sub-unit operative to receive the at least one synchronization signal from the at least one UE modem and to employ the at least one synchronization signal to synchronize internal functions of the base station sub-unit.

Preferably, the base station sub-unit is one of FDD or TDD.

Preferably, the base station sub-unit is a 5G or later generation standard base station sub-unit.

Preferably, the unit also includes a bi-directional communication protocol for bi-directional exchange of information between the UE modem and the base station sub-unit.

Preferably, the synchronization signal is a 1pps signal.

There is also provided, in accordance with yet another preferred embodiment of the present invention, a cellular base station unit including at least one user equipment (UE) modem operative to receive wireless signals from at least one external base station and to derive at least one synchronization signal from the signals received from the at least one external base station, a base station sub-unit operative to receive the at least one synchronization signal from the at least one UE modem and to employ the at least one synchronization signal to synchronize internal functions of the base station sub-unit, and a bi-directional communication protocol between the UE modem and the base station sub-unit for bi-directional exchange of information therebetween.

Preferably, the base station sub-unit is a 5G or later generation base station sub-unit.

Preferably, the UE modem does not include a SIM.

Preferably, the synchronization signal is a 1pps signal.

In accordance with a preferred embodiment of the present invention, there is also provided a method for synchronizing a cellular base station unit, including employing a cellular base station unit operative in accordance with any one of the preceding embodiments.

### BRIEF DESCRIPTION OF DRAWINGS

The present invention will be understood and appreciated from the following detailed description, taken in conjunction with the drawings in which:

FIG. 1 is a simplified partially pictorial, partially block diagram illustration of a base station unit, constructed and operative in accordance with a preferred embodiment of the present invention in the context of a wireless communication network;

FIG. 2 is a simplified illustration of one possible implementation of the base station unit of FIG. 1;

FIG. 3 is a swim lane diagram showing at least a portion of a communication protocol employed by a base station unit of the type shown in FIGS. 1 and 2, in accordance with a preferred embodiment of the present invention;

FIG. 4 is a swim lane diagram showing a communication protocol between components of a base station unit of the type shown in FIGS. 1 and 2;

FIG. 5 is a simplified partially pictorial, partially block diagram illustration of a base station unit constructed and operative in accordance with another preferred embodiment of the present invention; and

FIGS. 6A, 6B and 6C are simplified flow charts respectively illustrating steps in a method for base station synchronization in accordance with preferred embodiments of the present invention.

### DETAILED DESCRIPTION OF PREFERRED EMBODIMENT

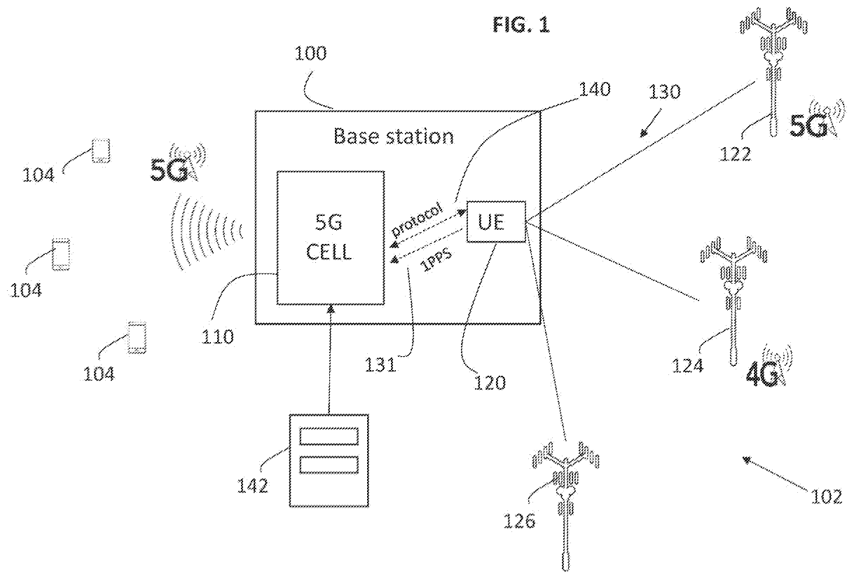

Reference is now made to FIG. 1, which is a simplified partially pictorial, partially block diagram illustration of a base station unit, constructed and operative in accordance with a preferred embodiment of the present invention, in the context of a wireless communication network.

As seen in FIG. 1, there is provided a base station unit 100 configured to co-operate with and form a part of a wireless cellular communication network 102. Base station unit 100 is particularly preferably a fifth generation (5G) standard cellular base station unit configured to transmit 5G signals to and receive 5G signals from various user equipments (UEs) 104. UEs 104 may be any type and number of UEs, such as a smart phone, a lap top computer or any other device capable of supporting 5G communication. In other embodiments of the present invention, base station unit 100 may be a later generation unit than 5G and UEs 104 may be capable of supporting 5G or later generation communication.

Base station unit 100 preferably includes a base station sub-unit 110 operative to perform various base station internal functions and processes involved in the operation thereof. By way of example only, base station sub-unit 110 may be embodied as a gNB (Next Generation Node B), as a component of a split gNB, such as a radio unit (RU) or as any other suitable 5G base station sub-unit capable of carrying out at least some of the internal functions or processes involved in the operation of base station 100. Base station sub-unit 110 is given the nomenclature ‘5G cell’ in FIG. 1, for the purpose of generality.

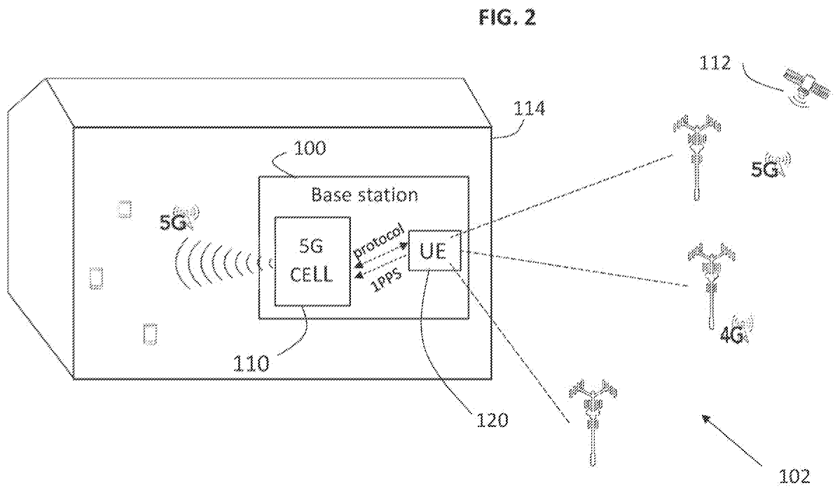

It is important for the proper functioning of base station 100 that the various internal functions or processes of base station sub-unit 110 are mutually synchronized. Typically, the synchronization of a base station such as base station 100 may be achieved by synchronizing the base station to a GNSS satellite signal. However, in certain contexts, it may be necessary or useful to synchronize base station 100 without use of GNSS satellite signals. For example, base station 100 may be an indoor base station, as shown in FIG. 2, with little or no reception of signals from a GNSS satellite 112 due to the blocking or attenuation of signals by a building 114 within which base station 100 is located. Further by way of example, base station 100 may be an outdoor base station that is nonetheless unable to synchronize using GNSS satellite signals for various possible reasons, including by way of example, poor weather conditions or GNSS jamming.

It is a particular feature of a preferred embodiment of the present invention that the base-station sub-unit 110 may be synchronized without necessarily requiring a GNSS signal, based on an alternative synchronization method employing a standard UE modem 120, shown in FIG. 1. The synchronization achieved using the UE modem 120 is referred to interchangeably herein as synchronization of the base-station sub-unit 110 and synchronization of the base station 100 and broadly refers to the synchronization of the internal functions or processes performed within base station 100 and particularly within base-station sub-unit 110 thereof. It is appreciated that a distinction is made here between base station 100 and base station sub-unit 110 for the sake of clarity of explanation of the functions thereof. However, in certain cases, base station unit 100 may be the same entity as base station sub-unit 110 and UE modem 120 may be incorporated therein. It is further appreciated that although a single UE modem 120 is shown in FIG. 1, base station 100 may include more than one UE modem 120. This may be beneficial, for example in order to provide redundancy benefits.

Referring again to FIG. 1, UE modem 120 is preferably incorporated within base station 100 and is in operative communication with base station sub-unit 110. UE modem 120 may be any standard UE modem or module, commercially available, for example from Ublox, of Thalwil, Switzerland. UE modem 120 may, or may not, include a Subscriber Identity Module (SIM), as is described in greater detail henceforth.

UE modem 120 is preferably operative to receive wireless signals from at least one base station external to base station 100. Here, by way of example only, UE modem 120 is shown to receive wireless signals from one or more of a first 5G base station 122, a second LTE 4G base station 124 and a third LTE-M and/or NB-IoT base station 126. It is appreciated, however, that UE modem may receive wireless signals from any suitable base station or base stations capable of transmitting signals receivable by UE modem 120. The signals received by UE modem 120 from at least one external base station, such as base station 122, 124 and/or 126, may be generally referred to as wireless signals, here indicated generally by reference number 130. Wireless signals 130 comprise at least one of 5G standard signals, Long Term Evolution (LTE) standard signals, LTE-Machine Type Communication (LTE-M) standard signals and Narrowband Internet of Things (NB-IoT) standard signals.

UE modem 120 is preferably operative to use the cell physical layer signals, such as PSS and SSS synchronization signals included in wireless signals 130 so as to ‘lock’ the UE modem 120 to the base station, such as base station 122, 124 or 126 transmitting the wireless signals 130, and to derive a synchronization signal 131 based on the received signals 130. Particularly preferably, UE modem 120 is operative to derive a 1pps signal based on the wireless signals 130, as shown in FIG. 1.

In one preferred embodiment of the present invention, base station sub-unit 110 may receive instructions from a management system thereof, indicating with which one or ones of external base stations 122, 124 and 126 UE modem 120 should choose to communicate. Base station sub-unit 110 may then direct UE modem 120 regarding which one or more base stations to choose.

In another embodiment of the present invention, UE modem 120 may itself include an algorithm for selecting the most suitable base station(s) with which to communicate. Such an algorithm may select a suitable base station from amongst available base stations broadcasting wireless signals receivable by UE modem 120 based on one or more of the following attributes: received signal quality level, base station stratum level as reported by the base station and base station operator identity as reported by the base station in the form of Public Land Mobile Network Identity (PLMN ID). By way of example, UE modem 120 may select the most suitable external base station with which to communicate as that base station having the highest received signal quality level, as that base station having the highest stratum level or based on the base station operator identity, or based on any metric reflecting a combination of one or more of the preceding attributes or other relevant attributes. The UE may also take additional actions based on the base station attributes. For example, the UE may apply an additional timing offset based on PLMN ID.

UE modem 120 may have two modes of operation, depending on whether base station sub-unit 110 is an FDD (frequency division duplex) or TDD (time division duplex) base station unit.

In the case that base station sub-unit 110 is a TDD base station unit, base station unit 110 may instruct the UE modem 120 to initiate a timing advance procedure with respect to one or more of external base stations 122, 124 and 126. Such a timing advance procedure is necessary in order to compensate for the propagation delay in the downlink signals due to the physical distance between the UE modem 120 and the external base stations, for the purpose of phase synchronization of the UE modem 120 to the one or more external base stations. In this case, the UE modem may receive the timing advance from the one or more external base stations.

In the case that base station sub-unit 110 is an FDD base station unit, base-station unit 110 may instruct the UE modem 120 not to initiate a timing advance procedure, since such a timing advance calculation is not necessary for the frequency synchronization required for FDD. In this case, the UE modem 120 may generate a synchronization signal without receiving timing advance from the external base stations. It is appreciated, however, that in some cases, base station sub-unit 110 may instruct UE modem 120 to initiate a timing advance calculation procedure even in the case that base station sub-unit 110 is an FDD base station unit, depending on the specific functionalities thereof.

It is a particular feature of one preferred embodiment of the present invention that UE modem 120 may receive the timing advance from the external base station(s) without requiring the inclusion in UE modem 120 of a Subscriber Identity Module (SIM). This is in contrast to conventional UE modems, which typically require a SIM in order to initiate a timing advance procedure with respect to external base stations. In such typical wireless communication systems, a UE modem 120 must include a SIM in order to communicate with a base station so as to receive the timing advance. In the absence of a SIM, such communication is halted as unauthorized and the UE modem cannot correct the time thereof due to the propagation delay.

However, advantageously, in a preferred embodiment of the present invention, UE modem 120 does not necessarily include a SIM and nonetheless may receive a timing advance value. This is achieved in the present invention by the UE modem being configured to allow back-and-forth communication with the base stations, such as base stations 122, 124 or 126, until the timing advance value is supplied thereto, following which such communication may or may not be stopped. The timing advance value is thus obtained, allowing phase synchronization of the UE modem to the base station, without requiring a SIM. It is understood, however, that in some embodiments UE 120 may include a SIM, both in the case of FDD and TDD.

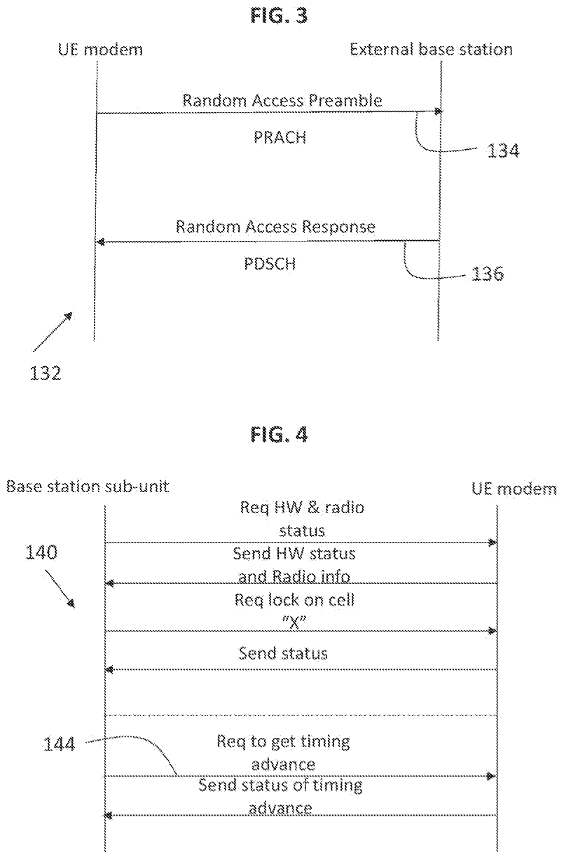

Turning now to FIG. 3, an exemplary communication protocol 132 between UE modem 120 not including a SIM and an external base station, such as base station 122, 124, or 126, is shown, whereby which communication protocol 132 UE modem 120 may obtain the timing advance value. As seen in FIG. 3, UE modem 120 may initially send a PRACH message 134 in the form of a Random Access Preamble to the external base station. In response to the message 134, the external base station, such as base station 122, 124 or 126, may send a PDSCH message 136 to UE modem 120, in the form of a Random Access Response. The exchange of messages 134 and 136 between UE modem 120 and the external base station is sufficient to allow UE modem 120 to obtain timing information and more specifically the timing advance value. Following the receipt of message 136 by UE modem 120, UE modem 120 may be configured to cease communication with the external base station. Alternatively, in some embodiments of the present invention, UE modem may continue communicating with the external base station, after receipt of message 136, by sending one or more additional messages. It is appreciated that as a result of UE modem 120 not including a SIM, UE modem 120 may advantageously obtain the timing advance value from any available frequency band of communication, rather than being limited to a particular subscribed band.

It is understood that conventional UE modems not including a SIM would typically be configured not to send the initial PRACH message 134. It is particular feature of the UE modem of the present invention that the UE modem 120 is configured to send PRACH message 134, to which PRACH message 134 the external base station responds, despite the UE modem 120 not including a SIM.

Returning to FIG. 1, irrespective of the particular nature of the frequency or phase synchronization of the UE modem to the base stations, the UE modem is preferably operative to derive a synchronization signal, such as a 1pps signal, based on the wireless signals 130 and to provide the synchronization signal to the base station sub-unit 110 by way of a communication protocol 140.

Base station sub-unit 110 is preferably operative to receive the synchronization signal from the UE modem 120 and to employ the synchronization signal to synchronize the internal functions thereof, without necessarily requiring reference to any external atomic clock or time.

It is a further particular feature of the present invention that, in some embodiments of the present invention, it may be preferable for the base station sub unit 110 to be aligned an external reference time representation, such as the time of day (ToD). In certain embodiments, particularly for more complex operations of base station 100, alignment to such an external reference time may be important. Alignment of the base station sub-unit 110 to an external time may be achieved, by way of example, by the base station sub-unit 110 retrieving the time from a network time protocol (NTP) 142.

In certain embodiments of the present invention, base station sub-unit 110 may be operative to provide information or queries to UE modem 120 and UE modem 120 may be operative to function based on the information or queries.

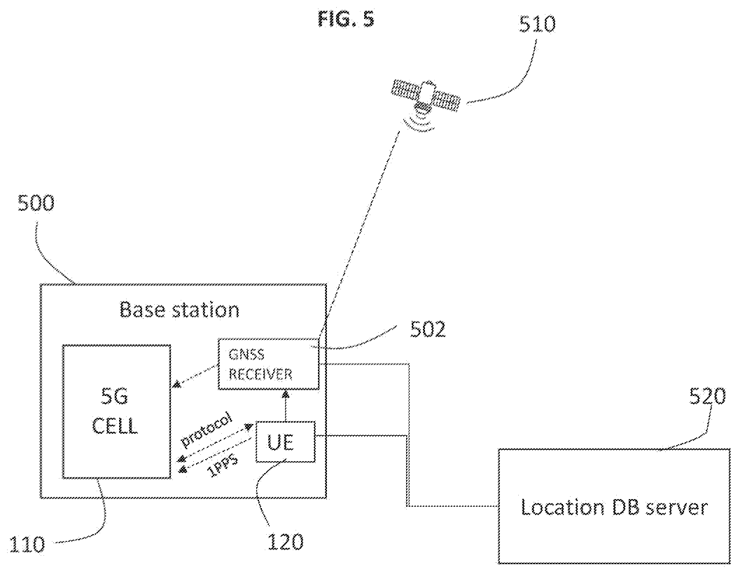

In some cases, there may be bi-directional communication between the base station sub-unit 110 and the UE modem 120. For example, as described above, this may be for the purpose of the base station sub-unit 110 advising the UE modem 120 with which base station to communication, or for the base station sub-unit 110 instructing UE modem 120 regarding whether or not to initiate communication with an external base station for the purpose of receiving the timing advance therefrom. It is understood that the bi-directional communication between the base station sub-unit 110 and the UE modem 120 may be facilitated by bi-directional communication protocol 140. Bi-directional communication protocol 140 may additionally or alternatively be used to transfer other information between the base station sub-unit 110 and the UE modem 120. Furthermore, in certain embodiments, bi-directional communication between the UE modem 120 and the base station sub-unit 110 may not be necessary, and communication protocol 140 may be simplified to be a single directional protocol, only providing information from the UE modem 120 to the base station sub-unit 110. An example of a possible bi-directional communication protocol 140, including a request for the UE modem 120 to get timing advance at a step 144, is shown in FIG. 4.

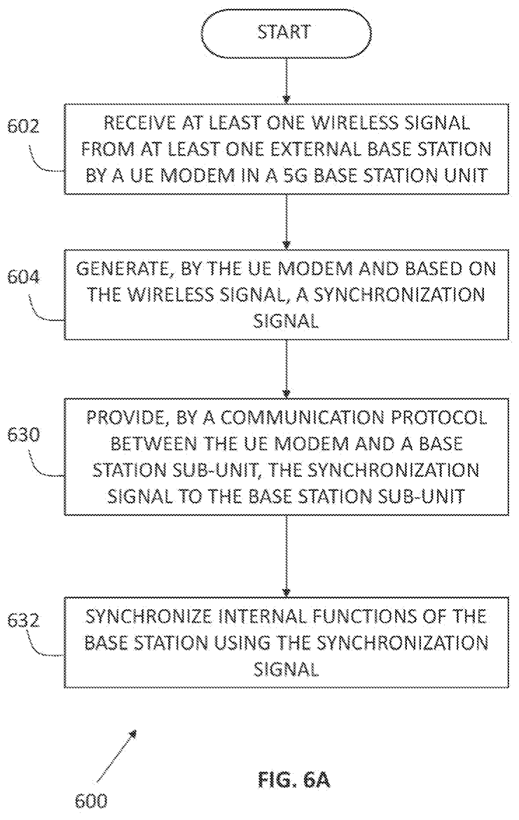

Reference is now made to FIG. 5, which is a simplified partially pictorial, partially block diagram illustration of a base station unit in the context of a wireless communication network, constructed and operative in accordance with another preferred embodiment of the present invention.

As seen in FIG. 5, and as described hereinabove, a base station 500 may include UE modem 120, base station sub-unit 110 and communication protocol 140 for facilitating exchange of information therebetween. As further described hereinabove and shown in FIG. 1 but not in FIG. 5, base station 500 may, in a similar manner as base station 100 of FIGS. 1 and 2, form a part of wireless communication network 120 and receive wireless signals 130 from external base stations 122, 124 and/or 126. Base station 500 may generally include some or all of the functionalities described above with reference to FIGS. 1-4 in relation to base station 100.

It is a particular feature of the embodiment of base station 500 shown in FIG. 5 that base station 500 preferably includes a GNSS receiver 502 for receiving GNSS signals from at least one GNSS satellite, such as a satellite 510. In the case that base station 500 is employed in an environment in which GNSS receiver 502 has satisfactory receipt of signals from at least four GNSS satellites to generate a time synchronization signal, as is conventionally required, base station 500 may be synchronized based on synchronization signals generated by GNSS receiver 502.

In the case that base station 500 is employed in an environment in which base station 500 does not have satisfactory receipt of GNSS signals from GNSS satellites, base station 500 may achieve synchronization as described hereinabove, based on synchronization signals derived by UE modem 120, rather than based on synchronization signals derived based on GNSS signals.

However, in certain circumstances, base station 500 may have access to signals from at least one GNSS satellite, such as GNSS satellite 510, although not from four GNSS satellites. It is a particular feature of a preferred embodiment of the present invention that, under such circumstances, base station 500 may be time synchronized by GNSS receiver 502 based on receipt of a signal from only a single GPS satellite, such as satellite 510. This is in contrast to conventional GNSS time synchronization systems which typically require communication with at least four GNSS satellites in order to achieve time synchronization of a network element. Communication with four GNSS satellites is typically required for time synchronization due to the presence of four unknown parameters in the GPS range p calculation equation:

pⱼ=\sqrt{(xⱼ−xᵤ)²+(yⱼ−yᵤ)²+(zⱼ−zᵤ)²}+ctᵤ (1)

wherein xᵤ, yᵤ and zᵤ represent the three dimensional coordinates of a particular satellite location, which coordinates are encoded in the signal transmitted by the satellite, and the four unknown parameters are network element j latitude, xⱼ, longitude, yⱼ, height, zⱼ, and receiver time offset ctᵤ.

In accordance with a preferred embodiment of the present invention, the GPS range calculation equation (1) may be solved in order to find the receiver time offset ctᵤ and thus time synchronize the receiver 502 based on communication with only a single GNSS satellite, rather than four satellites, by supplying the three dimensional coordinates of the location of the UE modem 120 to the GNNS receiver 502, such that only a single unknown remains to be solved for in equation (1).

In this embodiment, the geographical location of UE modem 120 may be ascertained based on triangulation techniques, as are well known in the art. As is well known in the art, based on characteristics of wireless signals, such as signals 130, received from base stations external thereto, the location of UE modem 120 may be calculated, which location corresponds to the geographical location of base station 500 within which UE modem 120 is located. The geographical location of UE modem 120 may be a three-coordinate geographical location.

In one preferred embodiment of the present invention, UE modem 120 may request a location database (DB) server 520 to calculate the location of UE modem 120, using triangulation techniques. DB server 520 is preferably communicably coupled to UE modem 120. DB server 520 may additionally be communicably coupled to GNSS receiver 502.

The location of base station 500 stored in DB server 520 may be provided to the UE modem 120, which UE modem 120 in turn supplies the location to GNSS receiver 502. Alternatively, DB server 520 may supply the location of UE modem 120 directly to GNSS receiver 502. The provision of the, preferably three-coordinate, geographical location of the base station 500 and the signal from a single GNSS satellite are preferably sufficient to allow the GNSS receiver 502 to time synchronize to the atomic clock of the GNSS satellite 510. Base station 500 may include both GNSS receiver 502 and UE modem 120. Base station sub-unit 110 may instruct UE modem 120 to provide a synchronization signal thereto in the case that GNSS receiver 502 is incapable of providing a synchronization signal to base station sub-unit 110, for example by way of communication protocol 140.

Synchronization of the GNSS receiver based on provision of the 3-coordinate geographical location and a signal from only a single GNSS satellite, such as satellite 510, is further described in U.S. patent application Ser. No. 16/748,053 which is fully incorporated herein by reference and assigned to the same assignee as the present application.

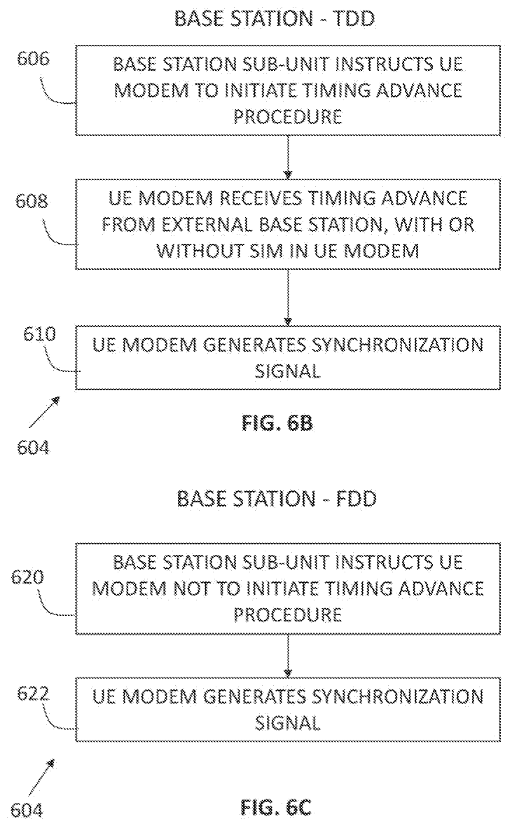

Reference is now made to FIGS. 6A, 6B and 6C, which are simplified flow charts respectively showing steps in a method for synchronization of a base station, in accordance with a preferred embodiment of the present invention. As seen in FIG. 6A, a synchronization process 600 may begin at a step 602, at which at least one wireless signal is received by at least one UE modem located in a 5G base station. As seen at a further step 604, the UE modem may generate synchronization timing information from the wireless signals, based on which a synchronization signal may be generated. Turning now to FIGS. 6B and 6C, the generation of the synchronization signal in the case of a TDD regime (FIG. 6B) and an FDD regime (FIG. 6C) of the base station sub-unit is shown.

In the case of a TDD regime, as shown in FIG. 6B, the base station sub-unit may instruct the UE modem to initiate a timing advance procedure, as seen at a step 606. The UE modem may initiate the timing advance procedure based on communication with the at least one external base station and may receive the timing advance therefrom, irrespective of whether the UE modem does or does not include a SIM, as seen at a step 608. The UE modem may then generate a synchronization signal, as seen at a step 610.

In the case of a FDD regime, as shown in FIG. 6C, the base station sub-unit may instruct the UE modem not to initiate a timing advance procedure, as seen at a step 620. The UE modem may then generate a synchronization signal, as seen at a step 622.

The synchronization signal, in both the FDD and TDD regimes, may be a 1pps signal or any other suitable synchronization signal, such as a 10 MHz signal, or 2 MHz or any other suitable high frequency signal.

Returning to FIG. 6A, following the generation of a synchronization signal, the synchronization signal generated by the UE modem may be provided to the base station and more particularly to a base station sub-unit included in the base station, as seen at a step 630. The base station sub-unit is preferably responsible for performing various functions and processes within the base station, requiring synchronization. As seen at a further step 632, the base station sub-unit may synchronize the internal functions thereof, based on the synchronization signal supplied thereto.

It will be appreciated by persons skilled in the art that the present invention is not limited by what has been described hereinabove. Rather the present invention includes both combinations and sub-combinations of features described hereinabove as well as modifications thereof which are not in the prior art.

1. A fifth generation (5G) standard cellular base station unit comprising:
at least one user equipment (UE) modem operative to receive wireless signals from at least one external base station and to derive at least one synchronization signal based on said wireless signals received from said at least one external base station; and
a 5G base station sub-unit operative to receive said at least one synchronization signal from said at least one UE modem and to employ said at least one synchronization signal to synchronize internal functions of said 5G base station sub-unit.

2. The unit according to claim 1, wherein said base station sub-unit is one of a gNB and a radio unit (RU).

3. The unit according to claim 1, wherein said UE modem does not include a Subscriber Identity Module (SIM) of any type.

4. The unit according to claim 3, wherein said UE modem is operative to communicate with said external base station until said UE modem receives from said external base station a timing advance value of said signals received from said external base station, and may or may not stop communicating with said external base station upon receiving said timing advance value.

5. The unit according to claim 1, and also comprising a bi-directional communication protocol between said base station sub-unit and said UE modem.

6. The unit according to claim 5, wherein:
said base station sub-unit is operative to provide information or queries to said UE modem; and
said UE modem is operative to function based on said information or queries.

7. The unit according to claim 1, wherein said base station sub-unit is operative to receive timing information from a network time protocol (NTP).

8. The unit according to claim 1 and also comprising a GNSS receiver included in said unit and in operative communication with said UE modem,
said UE modem being operative to ascertain a geographical location of said base station unit and to provide said geographical location to said GNSS receiver,
said GNSS receiver being operative to generate an additional synchronization signal based on said location and on a signal from at least one GNSS satellite,
said base station sub-unit being operative to receive said additional synchronization signal from said GNSS receiver and to employ said additional synchronization signal to time synchronize said base-station sub-unit with said at least one GNSS satellite.

9. The unit according to claim 1, wherein said wireless signals comprise at least one of 5G standard signals, Long Term Evolution (LTE) standard signals, LTE-Machine Type Communication (LTE-M) standard signals and Narrowband Internet of Things (NB-IoT) standard signals.

10. The unit according to claim 1, wherein said UE modem is operative to select said external base station and to derive said at least one synchronization signal based on said wireless signals received from said external base station based on at least one of:
a quality level of said wireless signals received from said external base station,
a base station stratum level of said external base station as reported by said external base station; and
a base station operator identity as reported by said external base station.

11. A cellular base station unit comprising:
at least one user equipment (UE) modem not including a Subscriber Identity Module (SIM) and operative to receive wireless signals from at least one external base station and to derive at least one synchronization signal from said wireless signals received from said at least one external base station; and
a base station sub-unit operative to receive said at least one synchronization signal from said at least one UE modem and to employ said at least one synchronization signal to synchronize internal functions of said base station sub-unit.

12. A unit according to claim 11, wherein said base station sub-unit is one of FDD or TDD.

13. A unit according to claim 11, wherein said base station sub-unit is a 5G or later generation standard base station sub-unit.

14. A unit according to claim 11, and also comprising a bi-directional communication protocol for bi-directional exchange of information between said UE modem and said base station sub-unit.

15. A unit according to claim 11, wherein said synchronization signal is a 1pps signal.

16. A cellular base station unit comprising:
at least one user equipment (UE) modem operative to receive wireless signals from at least one external base station and to derive at least one synchronization signal from said signals received from said at least one external base station;
a base station sub-unit operative to receive said at least one synchronization signal from said at least one UE modem and to employ said at least one synchronization signal to synchronize internal functions of said base station sub-unit; and
a bi-directional communication protocol between said UE modem and said base station sub-unit for bi-directional exchange of information therebetween.

17. A unit according to claim 16, wherein said base station sub-unit is a 5G or later generation base station sub-unit.

18. A unit according to claim 16, wherein said UE modem does not include a SIM of any type.

19. A unit according to claim 16, wherein said synchronization signal is a 1pps signal.

20. A method for synchronizing a cellular base station unit, comprising employing a cellular base station unit operative in accordance with claim 11.
